(19) United States
(12) Patent Application Publication
(10) Pub. No.: US 2025/0180595 A1
(43) Pub. Date: Jun. 5, 2025

(54) Liquid Velocity Meter for Installation in Pipes

(71) Applicant: METERRA TECH AS, Fredrikstad (NO)

(72) Inventor: Simon Strømnes Andersen, Fredrikstad (NO)

(21) Appl. No.: 18/862,023

(22) PCT Filed: May 2, 2023
(86) PCT No.: PCT/NO2023/050101

§ 371 Date: Oct. 31, 2024

(30) Foreign Application Priority Data
May 2, 2022 (NO) 20220500

(51) Int. Cl. G01P 5/02

(52) U.S. Cl. CPC G01P 5/02

(57) ABSTRACT

A liquid velocity meter for mounting in pipe, which comprises a turbulence-forming sensor housing arranged transversely in the pipe and where the turbulence-forming sensor housing has a triangular cross-section. The turbulence-forming sensor housing has a front surface facing the stream and two equal side surfaces with a top edge aligned with the stream and a sensor flag which extends in a direction of the stream out from the top edge, and with a root part mounted in a top part of the turbulence-forming sensor housing, where the sensor flag has two piezoelectric elements laminated on an elastic, electrically insulating layer.

### BACKGROUND

The disclosed embodiments relate to a liquid velocity meter which is mounted in pipes to primarily measure the velocity and volume flow of the fluid.

Piezoelectric sensors may use the piezoelectric effect to measure changes in pressure, acceleration, speed, temperature, load, or force by converting them into an electrical charge, to then convert the electrical charge into the intended unit of measurement.

For closed pipe systems, there are many different methods for measuring liquid velocity and often include primary instrumentation, such as sensor(s), mounted in a line/pipe cross-section, with cabling up to a room, or “shaft” where the equipment for signal processing is mounted. This equipment is usually available to personnel and often has the option of communicating with a more centrally located monitoring plant. Sensors are often mounted in the pipe, or are part of the pipe, and all or parts of the pipe system must be drained to access maintenance, replacement, or servicing of sensors. Sensors also require access to an external power source in order to be able to be read off and/or store and/or send measured data. There are often expensive sensors and expensive installation with demanding maintenance.

The South Korean publication KR 2011 0097278 A relates to a vertical collision portion arranged vertically to directly meet the fluid flow inside the pipe and a fluid flow behind the vertical collision portion. By providing a multi-functional sensor consisting of horizontal collision parts arranged horizontally with the flow and installing piezoelectric elements on their surfaces, the hydraulic pressure and flow rate of the fluid can be measured while self-power generation by hydraulic pressure is possible, allowing external.

The American patent from U.S. Pat. No. 5,627,322 from 1997 relates to a measurement sensor for a vortex flowmeter having a damming member, a scanning element disposed downstream of the damming member, and an electromechanical transducer associated with the scanning element and embedded therein, wherein a deformable compensating layer is provided at least in portions between the electromechanical transducer and the scanning element.

The Russian utility model, RU21239 U1, from 2001 is related to a vortex flowmeter transducer fixed in the pipeline and containing a sensitive element and a bluff body, including a front vortex-forming plate, intermediate and end sections, the sensing element is made in the form of two membranes located on the flat surfaces of the intermediate section of the bluff body symmetrically to its axis and the piezoelectric element, which differs due to the fact that the vortex flowmeter transducer is equipped with an additional piezoelectric element, grooves closed by membranes are made on opposite surfaces of the intermediate section of the bluff body, piezoelements are fixed in the grooves, located at a distance from the inner surface of the pipeline exceeding 0.2 of its internal diameter, and the space between the membranes and piezoelements filled with a binder dielectric material.

Publication, U.S. Pat. No. 5,913,247 A, in USA from 1999 is related to a transducer for a vortex flowmeter is used for the volume flow measurement of gaseous, liquid and vaporous media. In order to provide a particularly robust transducer for vortex flowmeters, which is suitable for high and low flow rates of gases, vapours and liquids with high and in particular low densities and is also suitable at high temperatures and high pressures and in the case of contaminated media with a high measurement sensitivity and optimum signal detection, a one-piece vortex body with a sensor integrated therein is to be used. The one-piece, triangular or trapezoidal vortex body is provided with vertical recesses in the vicinity of its tapering side walls, so as to form a compact vortex generation area, a vortex determination area and a vortex detection area as the minimum rigidity area.

The disclosed embodiments address one or more of these problems.

### SUMMARY

Disclosed herein is a liquid velocity meter for installation in pipes, comprising
a turbulence-forming sensor housing placed transversely in the pipe
where the turbulence-forming sensor housing has a triangular cross-section with:
a front surface facing a stream
and two equal side surfaces with a top edge aligned with the stream
a sensor flag that extends in the direction of the stream from the top edge, and with a root part mounted in a top part of the turbulence-forming sensor housing, characterized by
that the sensor flag has two piezoelectric elements laminated on an elastic, electrically insulating layer.

This configuration of the liquid velocity meter provides an advantage in that the fluctuations of the sensor flag, due to the turbulence from the liquid flowing towards and around the turbulence-forming sensor housing, forms a more alternating voltage signal in the piezoelectric elements and it is the voltage signal that is converted into a velocity signal for the liquid flow. This contributes to the liquid velocity meter measures with good precision, even at low liquid flow.

### BRIEF DESCRIPTION OF THE DRAWINGS

Preferred embodiments of the invention will be described in more detail below with reference to the accompanying figures, in which:

FIG. 1 shows the liquid velocity meter 0 in an embodiment where it is seen obliquely from the front, and where the direction of stream is shown towards a first end 41 of the turbulence-forming sensor housing 4.

FIG. 2 shows an embodiment of the turbulence-forming sensor housing 4 and sensor flag 1 seen from above.

FIG. 3 shows an embodiment of the sensor flag 1 seen from the side and where the sensor flag 1 is sectioned into 3 parts: root part 9, transition part 12 and main part 11 of sensor flag 1.

FIG. 4 shows the sensor flag 1 in an embodiment seen from above, where the two piezoelectric elements 2 are shown with an elastic, electrically insulating layer 21.

FIG. 5 shows an embodiment of the root part 9 of the sensor flag 1, where the root part 9 has a cone-shaped section that sits in the turbulence-forming sensor housing 4.

FIG. 6 shows an embodiment of the liquid velocity meter 0 attached to a sensor bracket 8 which is mounted in a T-branch 108.

FIG. 7 shows the same design as FIG. 2, but with an illustration of 2 different frequencies (f(1), f(2)) with their associated flow rates (V(1), V(2)) and sensor flag amplitudes (Δ(1, Δ(2)).

### DETAILED DESCRIPTION

Disclosed herein is a liquid velocity meter for installation in pipes, comprising a turbulence-forming transverse sensor housing where the turbulence-forming sensor housing has a triangular cross-section with a front surface facing the stream and two equal side surfaces with a top edge aligned with the stream and a sensor flag extending from the top edge, and with a root portion mounted in a top portion of the turbulence-forming sensor housing, characterized in that the sensor flag has two piezoelectric elements laminated on an elastic, electrically insulating layer.

In one embodiment, the elastic, electrically insulating layer is a biaxially oriented polyethylene terephthalate material. Biaxially oriented polyethylene terephthalate is a type of stretched polyester film. It is a highly elastic material, which is electrically insulating and has a high tensile strength. It is chemically stable and can act as both a gas and odor barrier. Well-known brand names such as Mylar, Melinex and Hostaphan are often used for such products. This particular type of stretched polyester film, or plastic, is perhaps better known by the abbreviation BoPET. The elastic, electrically insulating layer may extend from the root portion to near the end of the flag. Reinforced rubber or plastic may be another embodiment of the elastic, electro-insulating layer.

In another embodiment, the elastic, electrically insulating layer forms a distance between the piezoelectric elements and at the same time isolates them from each other, so that they are alternately stretched and compressed in their longitudinal directions by the sensor flag. The advantage of having two piezoelectric elements with a distance between them in the sensor flag, is to force the piezoelectric elements to alternately stretch and compress even more, so that they give off even stronger voltage signals.

In one embodiment, the sensor flag may have an elastic and insulating mantle that encloses the piezoelectric elements. This is to prevent wear and tear on the piezoelectric elements that are in the liquid stream. Another advantage of such a robust design is that the sensor flag will be maintenance-free during its lifetime, which is assumed to be 20 years. As long as the sensor flag is not damaged by foreign objects or gets any kind of coating.

In a further embodiment, the mantle may be an elastic and insulating and mechanically resistant protective layer, preferably silicone. The mantle may enclose both sides of the piezoelectric elements and parts, or the whole part, of the elastic, electrically insulating layer.

In an embodiment, the root part is wider than a main part of the sensor flag, with a circular segment-shaped transition part between the root part and the main part which has a vertical contour radius. A vertical contour radius in the transition between the root part and the main part of the sensor flag contributes to a smoother transfer of forces between the parts, and it takes more to get fatigue cracks in the transition area than with a perpendicular transition.

In an embodiment, the sensor flag has a bend or curvature in an outermost part of the sensor flag. The outermost end of the sensor flag is the end furthest from the turbulence-forming sensor housing. In one embodiment, there is a bend near ⅓ of the outermost part of the sensor flag. This is an advantage for sensor flags considering very low fluid velocities, which produce so little turbulence around the turbulence-formed sensor housing, so that sensor flag deflection/amplitude must be provoked by making a bend near the outermost part.

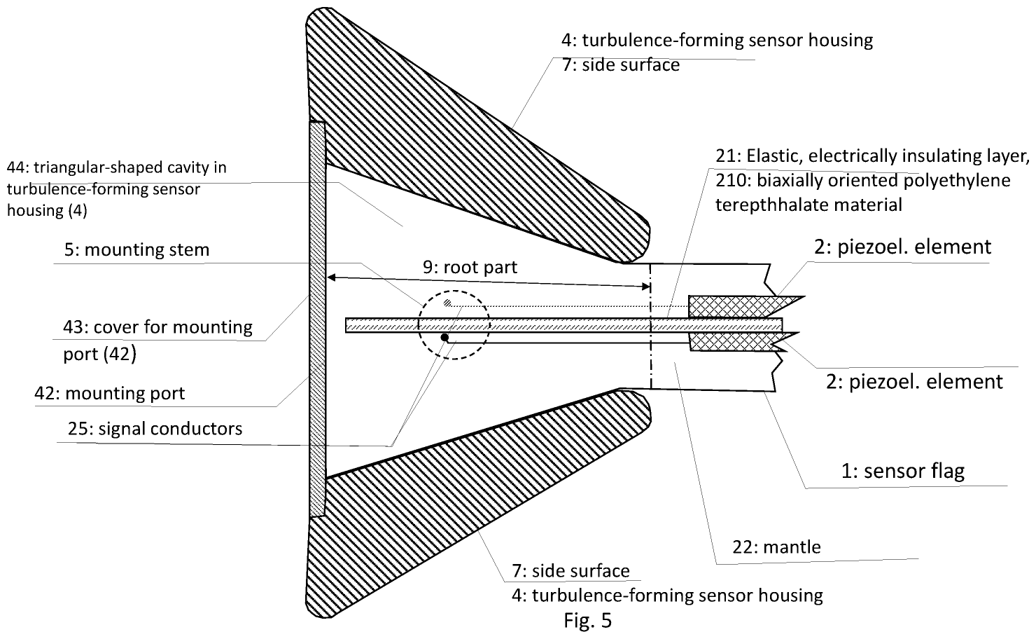

In another embodiment, the mantle may also include the root part and be designed to fit into the turbulence-forming sensor housing with the triangular cross-section, and fill all or parts of the turbulence-forming sensor housing, so that the sensor flag is held in the desired position, see in particular FIG. 5.

In another embodiment, the sensor flag is used to measure pressure. The advantage of having two piezoelectric elements is that pressure may be measured due to capacitance between the two piezoelectric elements. Only one sensor installed in the piping system is needed to measure both flow rate and pressure. Another advantage is that the difference in pressure loss may be read between several sensors that are installed in the same closed pipe system. This may also be used to detect leaks in the pipeline network.

In an embodiment, the piezoelectric element is used to generate electrical alternating voltage and thus energy. The generated energy may be used to recharge batteries, so that the energy may be stored and used later. The generated energy may, for instance, be used to send signals to an external receiver, store data and or add energy to process the voltage signals into speed and or pressure readings.

In one embodiment, the turbulence-forming sensor housing is arranged to extend diametrically in the pipe where it is arranged. The advantage of having the sensor housing diametrically is that it may be attached at both ends, so that it reduces vibrations in the turbulence-forming sensor housing. Another advantage is to avoid unwanted, unexplained turbulence of streams past the end of the triangular turbulence-forming sensor housing, turbulence frequencies that would only interfere with the more controllable conditions with the turbulence-forming sensor housing diametrically in the tube. The pipe where the turbulence-forming sensor housing is arranged may be a T-pipe, t-branch or ordinary straight pipe or curved pipe.

In another embodiment, the turbulence-forming sensor housing is arranged to extend partially diametrically in the pipe where it is arranged.

In an embodiment, a first end is mounted axially in a sensor bracket held in a T-branch of a pipe where a curved inner surface is in line with the pipe wall of the pipe. This is to achieve the same diameter around where the liquid velocity meter is arranged in the T-branch, as in the pipe where the T-branch is connected to. That again to measure the same volume flow past the turbulence-forming sensor housing in the T-branch, as if it were mounted in the pipe itself. The advantage is that one end of the T-branch may be equipped with a flange, so that there is access to the sensor bracket and the turbulence-forming sensor housing via the T-branch. This provides quick access to fluid velocity sensors for repair, maintenance, or replacement.

In an embodiment, the sensor bracket is designed to be pulled out and pushed in again. This is to be able to carry out replacements and maintenance on the liquid velocity meter. By installing the T-branch between two shut-off valves, maintenance or replacement of the turbulence-forming sensor housing may be done by blinding off the T-branch for a shorter period. It may also be possible to install a third shut-off valve, in connection with the sensor bracket, so that the entire sensor bracket may be lifted out of the pipe system and blinded off without having to shut off the liquid stream.

In another embodiment, the T-branch has a diameter corresponding to the pipe.

In another embodiment, the T-branch has a smaller diameter than the pipe.

In an embodiment, the turbulence-forming sensor housing is reversible about its longitudinal axis, so that the flag can be turned with the stream direction in the pipe. This has an advantage if the stream direction reverses, so that the sensor with the flag may be rotated about its own axis to stand with the front face facing the stream direction again.

In an embodiment, the turbulence-forming sensor housing detects that the stream direction is turning. In pipe systems that are interconnected as a ring, the stream direction may change several times within a short period, and it would then be an advantage if this is detected.

In an embodiment of, the sensor bracket is arranged to rotate 180 degrees about its axis. Where the turbulence-formed sensor housing, which is fixed in the sensor bracket, may be turned 180 degrees if the stream direction in the pipe reverses.

In an embodiment, the sensor bracket has motorized rotation. Where the sensor flag turns and becomes static—is turned/rotated by a motor. When turning by an electric motor or hydraulic motor with an electric pump, the energy used may come from a battery or several batteries, which again get all or some of the charge from the electrical energy produced by the piezoelectric elements.

In an embodiment, the sensor flag has piezoelectric elements that are used as an acoustic microphone to pick up sound in order to detect leaks. By having several such sensors with microphones placed over a pipeline network, in addition to detecting leaks, it is also possible to identify the location within which pair of sensors the leak is located.

In one embodiment, the liquid velocity meter is calibrated for the type of liquid it is installed in. In another embodiment, the liquid velocity meter is calibrated in a liquid with a corresponding viscosity to the liquid in which it is to be installed.

In an embodiment, the liquid velocity meter is calibrated for the type of pipe dimension in which it is installed. In a further embodiment, the liquid velocity meter may include electronics with software that includes algorithms to adapt the liquid velocity meter to the pipe dimension in which the liquid velocity meter is to be installed.

The liquid velocity meter may have a design that allows calibration to take place manually, remotely and or automatically. An advantage of remote calibration is that the sensor may be re-calibrated by an inner reduction of the pipe. Reduction of the inner pipe diameter may occur when a fouling is formed.

In one embodiment, the alternating voltage signal may be taken out over signal conductors, which may extend to a room, a shaft or in a T-branch, where the voltage signal may be measured, stored and or converted to output the fluid velocity.

In one embodiment, the liquid velocity meter may be used in liquid-filled pipes.

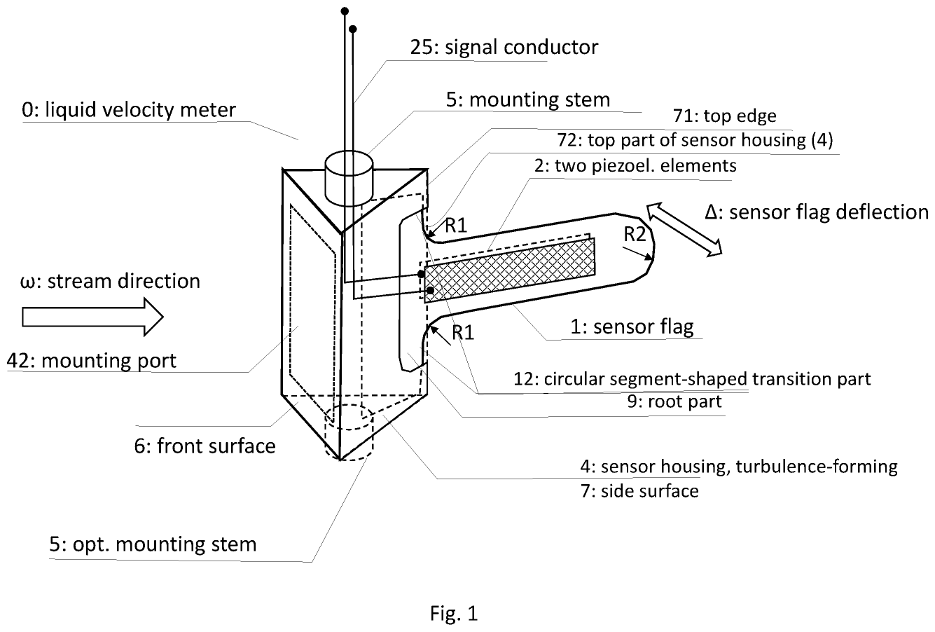

FIGS. 1-7 show one or more embodiments of a liquid velocity meter according to the disclosure.

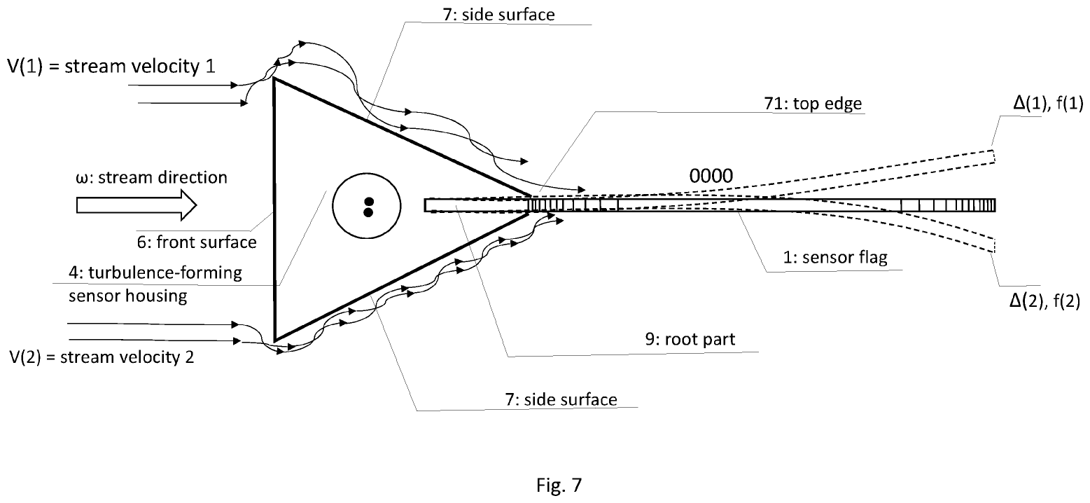

FIG. 1 shows an embodiment of the liquid velocity meter 0 with a turbulence-forming sensor housing 4. The turbulence-forming sensor housing 4 has a front surface 6, which is to face the stream direction ω, and where the front surface 6 has a mounting port 42. The mounting port 42 is arranged so that it is possible to carry out maintenance and/or replacements of components such as sensor flag 1, signal conductor(s) 25, root part 9 and/or piezoelectric element 2. The turbulence-forming sensor housing has two equal side surfaces 7, which extend from the front plate and obliquely backwards to the transition part with a vertical contour radius R1, 12, so that sensor flag 1 is perpendicularly mounted and backwards on the front plate 6 when stationary. The figure further shows a mounting stem 5 on top of the turbulence-forming sensor housing. The mounting stem 5 is also shown with two signal conductors 25 which are connected to the piezoelectric elements 2. There is also shown in the Figure an option to have an additional mounting stem at the bottom of the turbulence-forming sensor housing 4 or only mounting stem 5 at the bottom. If there is only one mounting stem at the bottom, the signal conductors 25 must pass through the mounting stem 5 at the bottom of the turbulence-forming sensor housing 4. The figure shows the sensor flag 1 shaped with a circular segment-shaped transition part 12 with a vertical contour radius R1 from a root part 9 to the sensor flag 1. Furthermore, the figure shows the sensor flag 1 with a flag end radius R2. The sensor flag 1 is also shown with the two piezoelectric elements 2 and how they are mounted inside the sensor flag 1 on each side and with one space, and which are each connected to a separate signal conductor 25. The turbulence-forming sensor housing 4 is shown with a top edge 71 and a top part 72 of the turbulence-forming sensor housing 4. Such a design may be symmetrical about the horizontal center of the turbulence-forming sensor housing 4. FIG. 1 further shows a sensor flag displacement/amplitude Δ, which occurs when a fluid flow with stream direction ω hits the turbulence-forming sensor housing 4, so that the two piezoelectric elements 2 which are mounted in the sensor flag will receive tensile and compressive stress in turn (this is shown in more detail in FIG. 7). The alternating voltage signal is taken out over signal conductors 25 and the voltage signal is measured and converted to output fluid velocity.

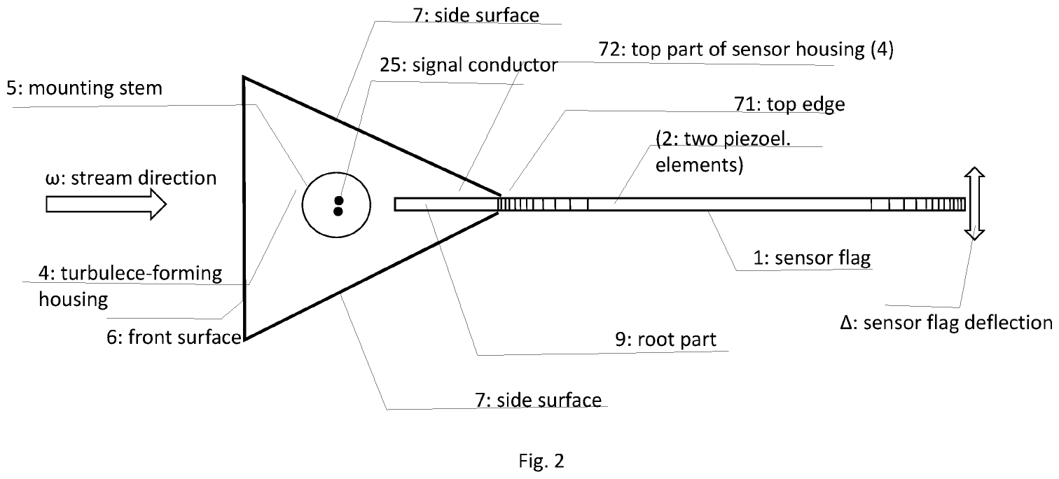

In FIG. 2, we see an embodiment of the liquid velocity meter seen from above and downwards on the turbulence-forming sensor housing 4 with a triangular cross-section. Here, in outline, shown with a front surface 6, two side surfaces 7, a sensor flag 1. The figure also shows the mounting stem 5, mounted on top of the turbulence-forming sensor housing 4 and with two signal conductors 25 pulled through. The turbulence-forming sensor housing 4 is shown with a top part 72 of the turbulence-forming sensor housing 4 and a top edge 71. The sensor flag 1 is indicated with two piezoelectric elements 2, which are installed inside the sensor flag 1. The sensor flag 1 is also shown with a root part 9 arranged inside it the turbulence-forming sensor housing 4. The stream direction ω is shown by the Figure perpendicular to the turbulence-forming sensor housing 4 and the sensor flag 1 is shown with a sensor flag displacement/amplitude Δ.

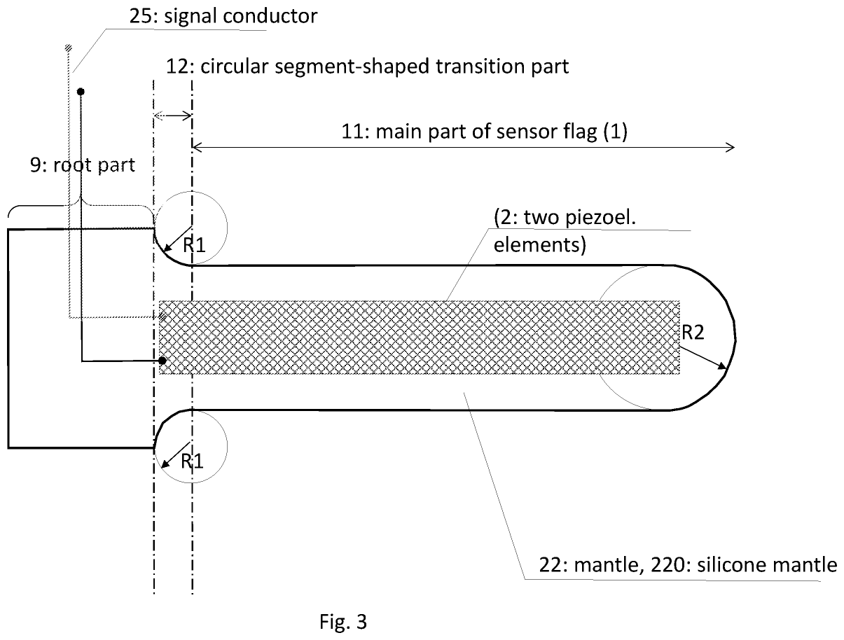

In FIG. 3 we see a more descriptive part of an embodiment of the sensor flag 1. FIG. 3 shows an embodiment of the sensor flag 1 divided into three parts, wherein
there is a root part 9 which may extend from the beginning of the sensor flag 1 to
a circular segment-shaped transition part 12 with a vertical contour radius R1, which extends further to
a main part 11 of the sensor flag 1 and which ends with a flag end radius R2.

FIG. 3 shows further an embodiment of the sensor flag 1 with a mantle 22 and where the mantle 22 may be a silicone mantle 220. The Figure also shows an embodiment of how the mantle 22 may encapsulate the two piezoelectric elements 2 and the signal conductors 25.

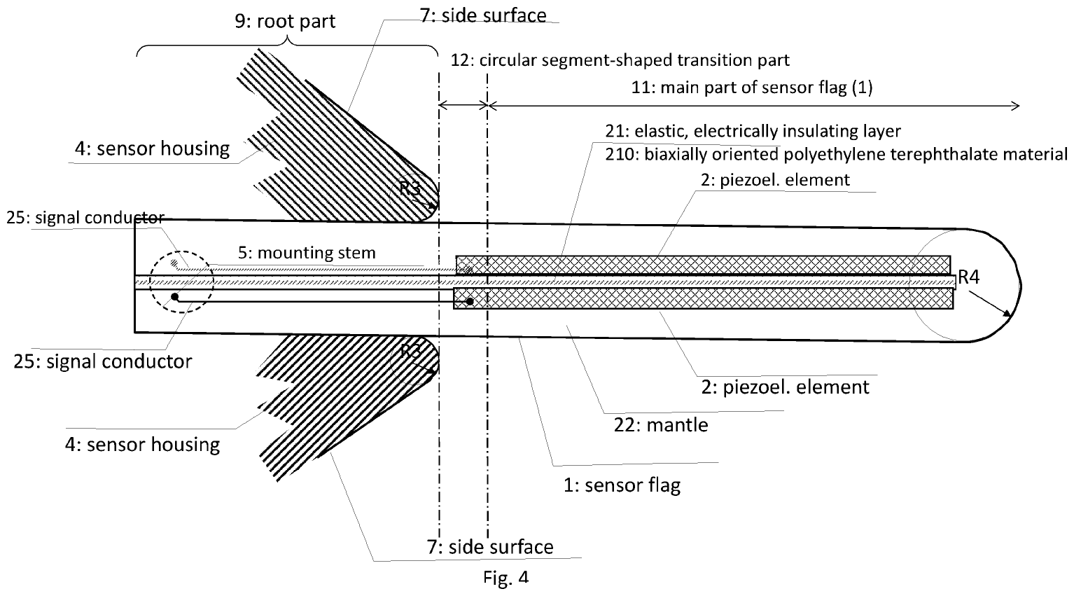

FIG. 4 shows an embodiment of sensor flag 1 which has two piezoelectric elements 2 laminated on an elastic, electrically insulating layer 21. The figure also shows an alternative embodiment where the elastic, electrically insulating layer 21 is a biaxially oriented polyethylene terephthalate material 210. The figure shows further, the sensor flag 1 with a root part 9 that extends between the two side surfaces 7 of the turbulence-forming sensor housing 4 and how the signal conductors may be drawn up and or down and through the dotted indication of a mounting stem 5. The figure shows a mantle 22 that encloses and encapsulates the two piezoelectric elements 2, the elastic, electrically insulating layer 21 and the signal conductors 25 through the turbulence-forming sensor housing 4. The figure also shows an embodiment where the main part 11 of the sensor flag 1 has a horizontal flag radius R4. An embodiment of how the sensor flag 1 is divided into three main parts, with a root part 9, a circular segment-shaped transition part 12 and a main part 11 of sensor flag 1 is also shown in the figure.

FIG. 5 shows an embodiment of the root part 9, and where the root part 9 fills the triangular-shaped cavity 44 in the turbulence-forming sensor housing 4. The triangular-shaped cavity in the turbulence-forming sensor housing 4 is designed so that the sensor flag 1 can be changed, in its entirety, out through mounting port 42, by removing the cover 43 for mounting port 42. The signal conductors 25 may thus be drawn out from the mounting stem 5, so that a new sensor flag 1 with signal conductors 25 may be mounted in the turbulence-forming sensor housing 4.

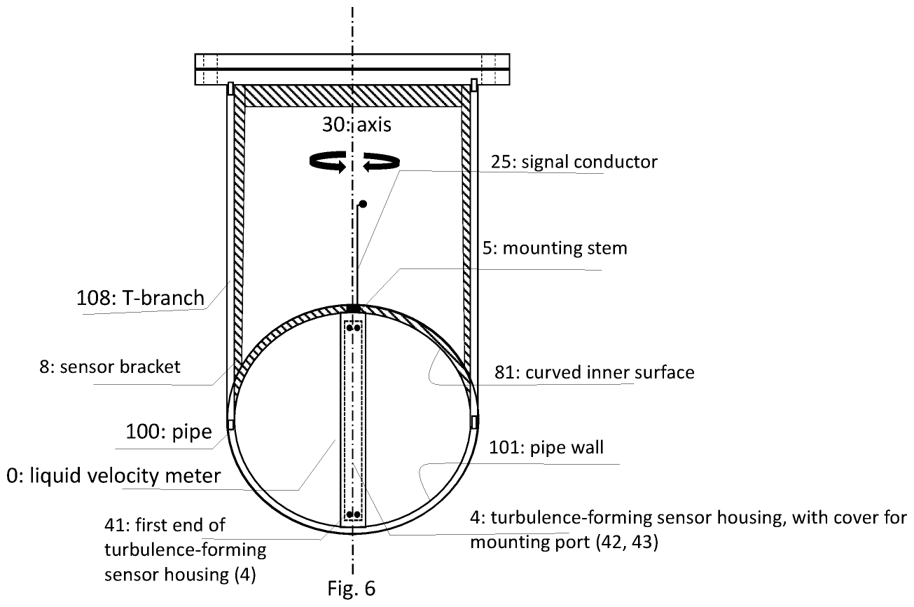

In FIG. 6, we see an embodiment of the turbulence-forming sensor housing 4 installed in a T-branch connected to a pipe 100. The figure also shows the turbulence-forming sensor housing 4 with a mounting stem 5, which is mounted in a sensor bracket 8. The figure also shows a signal conductor 25 which comes from the turbulence-formed sensor housing 4 and up via the mounting stem 5. The figure shows that the signal conductor 25 stops in the bracket, but another embodiment could be that the signal conductor 25 continues out of the T-branch 108 through the flange at the top. It is also clear from the figure how the sensor bracket 8 with its curved inner surface 81 is placed down into a pipe 100 via a T-branch 108. The figure also shows how pipe wall 101 in the T-branch 108 and the curved inner surface 81 of the sensor bracket 8 form a corresponding diameter as the pipe 100. Furthermore, we can see from the Figure that the entire sensor bracket 8 may be pushed out of the T-branch 108, so that repairs, maintenance and or replacements may be carried out. It is also shown in the Figure that an axis 30 which the sensor bracket 8 may be rotated around, in order to have the first end 41 of the turbulence-forming sensor housing 4 facing the stream direction, if it were to turn. Another embodiment is if only the turbulence-forming sensor housing 4 is rotated about its longitudinal axis. The rotation of the sensor bracket 8 and or the turbulence-forming sensor housing 4 may be done manually, with the help of a motor, an accumulator of some kind, and or that it is rotated automatically by changing the stream direction, so that the first end 41 of the turbulence-forming sensor housing 4 is always directed against the stream direction.

FIG. 7 shows an embodiment of the sensor flag 1, seen from above, where the sensor flag 1 is illustrated with two different frequencies (f(1) and f(2)), and with associated two different flow rates (V(1) and V(2)), of which f(1)<f(2) and V(1)<V(2). The figure also shows how the curvature of the sensor flag 1 shifts towards the end of the sensor flag 1 with increasing frequency. Alternating curvatures of the sensor flag 1 contribute to the alternating stretching and contraction of the piezoelectric elements 2 installed in the sensor flag 1. The figure also shows turbulence around the turbulence-forming sensor housing at the side surfaces 7.

### REFERENCE TABLE

| Reference | Description |
|---|---|
| R1 | Vertical contour radius |
| R2 | Vertical flag end radius |
| R3 | Side surface radius |
| R4 | Horizontal flag end radius |
| ω | Stream direction |
| Δ | Sensor flag deflection/amplitude |
| V | Flow rate |
| f | Frequency |
| 0 | Liquid velocity meter |
| 1 | Sensor flag |
| 2 | Piezoelectric element |
| 3 | |
| 4 | Turbulence-forming sensor housing |
| 5 | Mounting stem |
| 6 | Front surface |
| 7 | Side surface (turbulence-forming) |
| 8 | Sensor bracket |
| 9 | Root part |
| 10 | |
| 11 | Main part of sensor flag (1) |
| 12 | Circular segment-shaped transition part |
| 20 | |
| 21 | Elastic, electrically insulating layer |
| 22 | Mantle |
| 25 | Signal conductor(s) |
| 30 | Axis |
| 40 | |
| 41 | First end of turbulence-forming sensor housing |
| 42 | Mounting port |
| 43 | Cover for mounting port (42) |
| 44 | Triangular-shaped cavity in turbulence-forming sensor |
| | housing |
| 50 | |
| 60 | |
| 70 | |
| 71 | Top edge of turbulence-forming sensor housing |
| 72 | Top part of turbulence-forming sensor housings (4) |
| 80 | |
| 81 | Curved inner surface |
| 100 | Pipe |
| 101 | Pipe wall |
| 108 | T-branch |
| 200 | |
| 210 | Biaxially oriented polyethylene terephthalate material |
| 220 | Silicone mantle |

1-16. (canceled)

17. A liquid velocity meter (0) for mounting in a pipe (100), comprising
a turbulence-forming sensor housing (4) arranged transversely in the pipe (100), the turbulence-formed sensor housing (4) having a triangular cross-section with a front surface (6) facing the direction of a stream in the pipe (100), and two equal side surfaces (7) meeting at a top edge (71) aligned with the stream;
a sensor flag (1) extending from the top edge (71) in the direction of the stream and having a root part (9) mounted in a top part (72) of the turbulence-forming sensor housing (4), wherein
the sensor flag (1) comprises two piezoelectric elements (2) laminated on an elastic electrically insulating layer (21).

18. The liquid velocity meter (0) according to claim 17, wherein the elastic electrically insulating layer (21) is a biaxially oriented polyethylene terephthalate material (210).

19. The liquid velocity meter (0) according to claim 17, wherein the sensor flag (1) has an elastic and insulated mantle (22) enclosing the piezoelectric elements (2).

20. The liquid velocity meter (0) according to claim 17, wherein the sensor flag (1) further comprises a main part (11) with a circular segment-shaped transition part (12) having a vertical contour radius (R1) transitioning between the main part (11) and root part (9), wherein the root part (9) is wider than a main part (11) in a vertical direction of the sensor flag (1).

21. The liquid velocity meter (0) according to claim 17, wherein the sensor flag (1) is configured to measure pressure (P).

22. The liquid velocity meter (0) according to claim 17, wherein the piezoelectric element (1) is further configured to generate electrical alternating voltage, and thereby generate energy.

23. The liquid velocity meter (0) according to claim 18, wherein the piezoelectric element (1) is further configured to generate electrical alternating voltage, and thereby generate energy.

24. The liquid velocity meter (0) according to claim 17, wherein the turbulence-forming sensor housing (4) is arranged to extend diametrically in the pipe (100) within which it is arranged.

25. The liquid velocity meter (0) according to claim 17, wherein
the sensor housing (4) comprises a first end (41) mounted axially in a sensor bracket (8) held in a T-branch (108) of the pipe (100), and
a curved inner surface (81) is in line with the pipe wall (101) of the pipe (100).

26. The liquid velocity meter (0) according to claim 25, wherein the sensor bracket (8) is configured to be pulled out and pushed in again.

27. The liquid velocity meter (0) according to claim 25, wherein the T-branch (108) has a diameter corresponding to the pipe (100).

28. The liquid velocity meter (0) according to claim 25, wherein the T-branch (108) has a smaller diameter than the pipe (100).

29. The liquid velocity meter (0) according to claim 17, wherein the turbulence-forming sensor housing (4) is reversible about its longitudinal axis, so that the flag (1) can be turned with the liquid flow in the pipe (100).

30. The liquid velocity meter (0) according to claim 29, wherein the sensor bracket (8) is configured to rotate 180 degrees about its axis (30).

31. The liquid velocity meter (0) according to claim 30, wherein the sensor bracket (8) has motorized rotation.

32. The liquid velocity meter (0) according to claim 25, wherein the sensor bracket (8) is configured to rotate 180 degrees about its axis (30).

33. The liquid velocity meter (0) according to claim 17, wherein the sensor flag (1) piezoelectric elements (2) are configured to act as an acoustic microphone to pick up sounds and detect leaks.

34. The liquid velocity meter (0) according to claim 17, wherein said elastic electrically insulating layer (21) forms a distance between the piezoelectric elements (2) and isolates the piezoelectric elements (2) from each other so that the respective piezoelectric elements (2) are alternately stretched and compressed in their longitudinal directions by the sensor flag (1) deflections (Δ).

35. The liquid velocity meter (0) according to claim 18, wherein said elastic electrically insulating layer (21) forms a distance between the piezoelectric elements (2) and isolates the piezoelectric elements (2) from each other so that the respective piezoelectric elements (2) are alternately stretched and compressed in their longitudinal directions by the sensor flag (1) deflections (Δ).

36. The liquid velocity meter (0) according to claim 19, wherein said elastic electrically insulating layer (21) forms a distance between the piezoelectric elements (2) and isolates the piezoelectric elements (2) from each other so that the respective piezoelectric elements (2) are alternately stretched and compressed in their longitudinal directions by the sensor flag (1) deflections (Δ).
